(19) United States
(12) Patent Application Publication
(10) Pub. No.: US 2023/0342605 A1
(43) Pub. Date: Oct. 26, 2023

(54) MULTI-STAGE MACHINE-LEARNING TECHNIQUES FOR RISK ASSESSMENT

(71) Applicant: EQUIFAX INC., Atlanta, GA (US)

(72) Inventors: Yuvaraj SANKARAN, Atlanta, GA (US); Benjamin OBANDO, Santiago (CL); Danilo BUSTOS, Atlanta, GA (US)

(21) Appl. No.: 18/306,103

(22) Filed: Apr. 24, 2023

Related U.S. Application Data
(60) Provisional application No. 63/363,630, filed on Apr. 26, 2022.

(51) Int. Cl. G06N 3/08; G06Q 40/03

(52) U.S. Cl. CPC G06N 3/08; G06Q 40/03

(57) ABSTRACT

Certain embodiments involve providing explainable risk assessment via multi-stage machine-learning techniques. A risk assessment server can determine, in response to a risk assessment query for a target entity, a first risk indicator for the target entity by applying a first risk assessment model to predictor variables associated with the target entity. Responsive to determining that the first risk indicator indicates a risk higher than a threshold value, the risk assessment server can generate explanatory data for the predictor variables and determine a second risk indicator for the target entity by applying a second risk assessment model to the predictor variables associated with the target entity. A response message can be generated and transmitted to include the first risk indicator, the explanatory data, and the second risk indicator, for use in controlling access to one or more interactive computing environments by the target entity.

### CROSS-REFERENCE TO RELATED APPLICATIONS

This claims priority to U.S. Provisional Application No. 63/363,630, entitled “Multi-Stage Machine-Learning Techniques for Risk Assessment,” filed Apr. 26, 2022, the entirety of which is hereby incorporated by reference.

### TECHNICAL FIELD

The present disclosure relates generally to artificial intelligence. More specifically, but not by way of limitation, this disclosure relates to employing machine learning models for generating outputs (e.g., risk assessments) and for providing explainable outcomes associated with these outputs.

### BACKGROUND

Advanced machine-learning techniques, such as deep neural networks, can provide accurate predictions or assessments by relying on the complex structure of the neural network and the interconnections among the various nodes. However, the complex structure and interconnections can increase the difficulty of explaining relationships between an input variable and the output of the neural network. As such, explaining the impact of a specific input variable on the prediction results of the neural network might be infeasible or impractical. Less complex risk assessment models, such as models based on linear or logistic regression techniques, can provide more easily explainable outcomes due to the relatively simple relationship between the input variable and the output of these models. However, these simpler risk assessment models cannot provide predictions and assessments as accurate as more complex machine-learning models.

### SUMMARY

Various aspects of the present disclosure provide systems and methods for providing explainable risk assessment via multi-stage machine-learning techniques. In one example, a method that includes one or more processing devices performing operations. The method includes receiving, from a remote computing device, a risk assessment query for a target entity and determining, responsive to the risk assessment query, a first risk indicator for the target entity by applying a first risk assessment model to predictor variables associated with the target entity. The method further includes responsive to determining that the first risk indicator indicates a risk higher than a threshold value, generating explanatory data for the predictor variables, the explanatory data indicating an effect that a predictor variable has on the first risk indicator, and determining a second risk indicator for the target entity by applying a second risk assessment model to the predictor variables associated with the target entity. The method also includes transmitting, to the remote computing device, a response message including the first risk indicator, the explanatory data, and the second risk indicator, for use in controlling access to one or more interactive computing environments by the target entity.

In another example, a system includes a processing device and a memory device in which instructions executable by the processing device are stored for causing the processing device to perform operations. The operations include receiving, from a remote computing device, a risk assessment query for a target entity and determining, responsive to the risk assessment query, a first risk indicator for the target entity by applying a first risk assessment model to predictor variables associated with the target entity. The operations further include responsive to determining that the first risk indicator indicates a risk higher than a threshold value, generating explanatory data for the predictor variables, the explanatory data indicating an effect that a predictor variable has on the first risk indicator, and determining a second risk indicator for the target entity by applying a second risk assessment model to the predictor variables associated with the target entity. The operations also include transmitting, to the remote computing device, a response message including the first risk indicator, the explanatory data, and the second risk indicator, for use in controlling access to one or more interactive computing environments by the target entity.

In yet another example, a non-transitory computer-readable storage medium has program code that is executable by a processor to cause a computing device to perform operations. The operations include receiving, from a remote computing device, a risk assessment query for a target entity and determining, responsive to the risk assessment query, a first risk indicator for the target entity by applying a first risk assessment model to predictor variables associated with the target entity. The operations further include responsive to determining that the first risk indicator indicates a risk higher than a threshold value, generating explanatory data for the predictor variables, the explanatory data indicating an effect that a predictor variable has on the first risk indicator, and determining a second risk indicator for the target entity by applying a second risk assessment model to the predictor variables associated with the target entity. The operations also include transmitting, to the remote computing device, a response message including the first risk indicator, the explanatory data, and the second risk indicator, for use in controlling access to one or more interactive computing environments by the target entity.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

FIG. 1 is a block diagram depicting an example of a computing environment in which explainable multi-stage machine-learning models can be trained and applied in a risk assessment application according to certain aspects of the present disclosure.

FIG. 2 is a flow chart depicting an example of a process for utilizing multi-stage machine-learning models to generate risk indicators for a target entity based on predictor variables associated with the target entity, according to certain aspects of the present disclosure.

FIG. 3 is a diagram depicting an example of determining risk indicators based on multi-stage machine-learning models, according to certain aspects of the present disclosure.

FIG. 4 is a block diagram depicting an example of a computing system suitable for implementing certain aspects of the present disclosure.

### DETAILED DESCRIPTION

Certain aspects and features of the present disclosure for providing explainable risk assessment via multi-stage machine-learning techniques can address one or more issues associated with the existing risk assessment technologies. For example, a risk assessment computing system can maintain two risk assessment models: an explainable risk assessment model and a second-stage risk assessment model that is generated or configured without an explainability constraint. An example of an explainability constraint is a requirement that individual impacts of input variables of the risk assessment model on the output of the risk assessment model must be determinable. In response to receiving a risk assessment query for a target entity, the risk assessment computing system can apply the explainable risk assessment model to input predictor variables associated with the target entity to generate an initial risk indicator.

If the initial risk indicator indicates a high risk (e.g., a risk indicator above a certain threshold) associated with the target entity that can lead to an adverse action with respect to the target entity, such as a denial of the target entity’s access to certain resources, the risk assessment computing system can also generate an adverse action code for the target entity. The adverse action code can provide an explanation for the adverse action by, for example, identifying the predictor variables that led to the high risk indicated by the initial risk indicator. The risk assessment computing system can further apply the second-stage risk assessment model to the predictor variables associated with the target entity to generate an updated risk indicator. Because the complexity of the second-stage risk assessment model is higher than the explainable risk assessment model, the updated risk indicator can provide a better indication of the risk associated with the target entity. The risk assessment computing system can transmit a response message to the risk assessment query by including, in the response message, data such as the initial risk indicator, the reason code, and the updated risk indicator (if available). The initial risk indicator and the updated risk indicator included in the response message can be used for controlling access to one or more interactive computing environments by the target entity.

Certain aspects described herein provide improvements to the accuracy of risk assessment while maintaining the explainability of the assessment if needed. For instance, the explainable risk assessment model of the multi-stage machine learning model can be used to provide explanatory data for the predictions and the more advanced, second-stage risk assessment model can be used to provide more accurate (but not necessarily explainable) updated risk predictions. Both predictions can be used to assess the risk associated with a target entity. The combination of the two types of models as presented herein leverages the high predictive capability of the second-stage risk assessment model and the explainability of the explainable risk assessment model. As a result, explanatory data can be provided by the first-stage model and more accurate prediction can be provided by the second-stage risk assessment model to determine the risk assessment results.

Additional or alternative aspects can implement or apply rules of a particular type that improve existing technological processes involving risk assessment. For instance, the rules for applying the first-stage explainable model first to input predictor variables to generate an initial risk indicator allows the generation of the initial assessment and the explanatory data. The rules for applying the second-stage risk assessment model to the predictor variables associated with the target entity if the initial risk indicator indicates a high risk allows a more accurate risk assessment to be made for the target entity to avoid misidentification of risky entity or mis-denial of access of the target entity. As a result, both explainability and high accurate risk assessments can be achieved.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Operating Environment Example for Multi-Stage Machine-Learning Operations

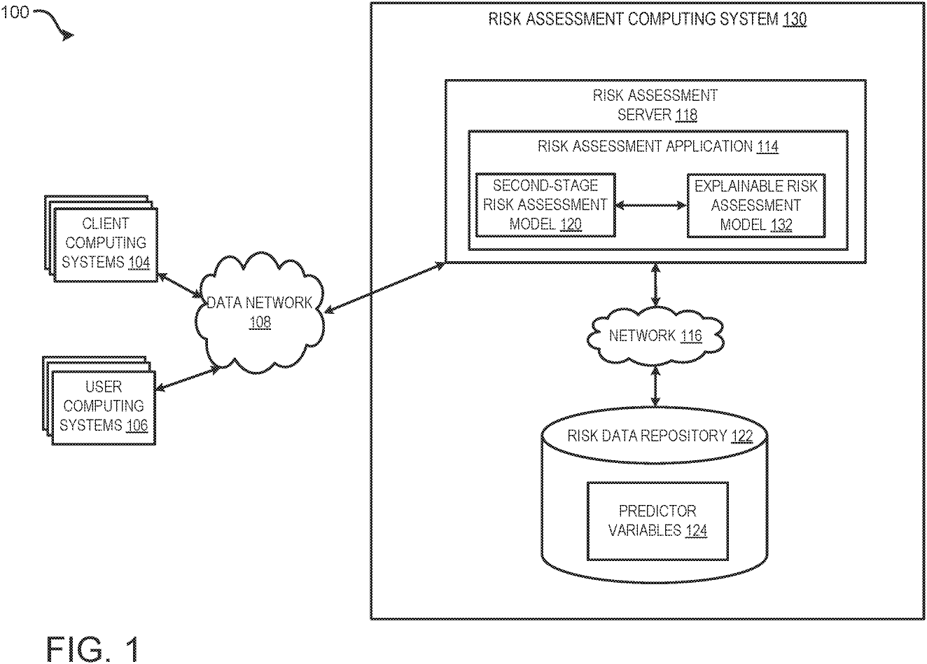

Referring now to the drawings, FIG. 1 is a block diagram depicting an example of an operating environment 100 in which a risk assessment computing system 130 maintains an explainable risk assessment model 132 and a second-stage risk assessment model 120 that can each be utilized to predict risk indicators based on predictor variables. FIG. 1 depicts examples of hardware components of a risk assessment computing system 130, according to some aspects. The risk assessment computing system 130 is a specialized computing system that may be used for processing large amounts of data using a large number of computer processing cycles. The risk assessment computing system 130 can include a risk assessment server 118 for performing risk assessment for given predictor variables 124 using the risk assessment models.

The risk assessment server 118 can include one or more processing devices that execute program code, such as a risk assessment application 114. The program code is stored on a non-transitory computer-readable medium. The risk assessment application 114 can execute one or more processes to utilize the explainable risk assessment model 132 and the second-stage risk assessment model 120 to predict risk indicators based on input predictor variables 124. In addition, the risk assessment models, such as the explainable risk assessment model 132, can also be utilized to generate explanatory data for the predictor variables, which indicate an effect or an amount of impact that a given predictor variable has on the risk indicator. In some examples, the predictor variables 124 can be stored in one or more network-attached storage units on which various repositories, databases, or other structures are stored. Examples of these data structures are the risk data repository 122.

The output of the risk assessment models can be utilized to modify a data structure in the memory or a data storage device. For example, the predicted risk indicator and/or the explanation data can be utilized to reorganize, flag, or otherwise change the predictor variables 124 involved in the prediction by the risk assessment models. For instance, predictor variables 124 stored in the risk data repository 122 can be attached with flags indicating their respective amount of impact on the risk indicator. Different flags can be utilized for different predictor variables 124 to indicate different levels of impacts. Additionally, or alternatively, the locations of the predictor variables 124 in the storage, such as the risk data repository 122, can be changed so that the predictor variables 124 or groups of predictor variables 124 are ordered, ascendingly or descendingly, according to their respective amounts of impact on the risk indicator.

By modifying the predictor variables 124 in this way, a more coherent data structure can be established which enables the data to be searched more easily. In addition, further analysis of the risk assessment models and the outputs of the risk assessment models can be performed more efficiently. For instance, predictor variables 124 having the most impact on the risk indicator can be retrieved and identified more quickly based on the flags and/or their locations in the risk data repository 122. Further, updating the risk assessment models, such as re-training the risk assessment models based on new values of the predictor variables 124, can be performed more efficiently especially when computing resources are limited. For example, updating or retraining the neural network can be performed by incorporating new values of the predictor variables 124 having the most impact on the output risk indicator based on the attached flags without utilizing new values of all the predictor variables 124.

The risk assessment computing system 130 can communicate with various other computing systems, such as client computing systems 104. For example, client computing systems 104 may send risk assessment queries to the risk assessment server 118 for risk assessment, or may send signals to the risk assessment server 118 that control or otherwise influence different aspects of the risk assessment computing system 130. The client computing systems 104 may also interact with user computing systems 106 via one or more data networks 108 to facilitate electronic transactions or interactions between users of the user computing systems 106 and interactive computing environments provided by the client computing systems 104.

Each client computing system 104 may include one or more third-party devices, such as individual servers or groups of servers operating in a distributed manner. A client computing system 104 can include any computing device or group of computing devices operated by a seller, lender, or other providers of products or services. The client computing system 104 can include one or more server devices. The one or more server devices can include or can otherwise access one or more non-transitory computer-readable media. The client computing system 104 can also execute instructions that provide an interactive computing environment accessible to user computing systems 106. Examples of the interactive computing environment include a mobile application specific to a particular client computing system 104, a web-based application accessible via a mobile device, etc. The executable instructions are stored in one or more non-transitory computer-readable media.

The client computing system 104 can further include one or more processing devices that are capable of providing the interactive computing environment to perform operations described herein. The interactive computing environment can include executable instructions stored in one or more non-transitory computer-readable media. The instructions providing the interactive computing environment can configure one or more processing devices to perform operations described herein. In some aspects, the executable instructions for the interactive computing environment can include instructions that provide one or more graphical interfaces. The graphical interfaces can be used by a user computing system 106 to access various functions of the interactive computing environment. For instance, the interactive computing environment may transmit data to and receive data from a user computing system 106 to shift between different states of the interactive computing environment. The different states can allow one or more electronic transactions between the user computing system 106 and the interactive computing environment to be performed.

A user computing system 106 can include any computing device or other communication device operated by a user, such as a consumer or a customer. The user computing system 106 can include one or more computing devices, such as laptops, smartphones, and other personal computing devices. A user computing system 106 can include executable instructions stored in one or more non-transitory computer-readable media. The user computing system 106 can also include one or more processing devices that are capable of executing program code to perform operations described herein. In various examples, the user computing system 106 can allow a user to access certain online services from a client computing system 104 or other computing resources, to engage in mobile commerce with a client computing system 104, to obtain controlled access to electronic content hosted by the client computing system 104, etc.

For instance, the user can use the user computing system 106 to engage in an electronic transaction with a client computing system 104 via an interactive computing environment. An electronic transaction between the user computing system 106 and the client computing system 104 can include, for example, the user computing system 106 being used to request online storage resources managed by the client computing system 104, acquire cloud computing resources (e.g., virtual machine instances), and so on. An electronic transaction between the user computing system 106 and the client computing system 104 can also include, for example, query a set of sensitive or other controlled data, access online financial services provided via the interactive computing environment, submit an online credit card application or other digital application to the client computing system 104 via the interactive computing environment, operating an electronic tool within an interactive computing environment hosted by the client computing system (e.g., a content-modification feature, an application-processing feature, etc.).

In some aspects, an interactive computing environment implemented through a client computing system 104 can be used to provide access to various online functions. As a simplified example, a website or other interactive computing environment provided by an online resource provider can include electronic functions for requesting computing resources, online storage resources, network resources, database resources, or other types of resources. In another example, a website or other interactive computing environment provided by a financial institution can include electronic functions for obtaining one or more financial services, such as loan application and management tools, credit card application and transaction management workflows, electronic fund transfers, etc. A user computing system 106 can be used to request access to the interactive computing environment provided by the client computing system 104, which can selectively grant or deny access to various electronic functions. Based on the request, the client computing system 104 can collect data associated with the user and communicate with the risk assessment server 118 for risk assessment. Based on the risk indicators predicted by the risk assessment server 118, the client computing system 104 can determine whether to grant the access request of the user computing system 106 to certain features of the interactive computing environment.

In a simplified example, the system depicted in FIG. 1 can configure the risk assessment models to be used both for accurately determining risk indicators (e.g., credit scores) using predictor variables and for determining adverse action codes or other explanatory data for the predictor variables. A predictor variable can be any variable predictive of risk that is associated with an entity. Any suitable predictor variable that is authorized for use by an appropriate legal or regulatory framework may be used.

Examples of predictor variables used for predicting the risk associated with an entity accessing online resources include, but are not limited to, variables indicating the demographic characteristics of the entity (e.g., name of the entity, the network or physical address of the company, the identification of the company, the revenue of the company), variables indicative of prior actions or transactions involving the entity (e.g., past requests of online resources submitted by the entity, the amount of online resource currently held by the entity, and so on.), variables indicative of one or more behavioral traits of an entity (e.g., the timeliness of the entity releasing the online resources), etc. Similarly, examples of predictor variables used for predicting the risk associated with an entity accessing services provided by a financial institute include, but are not limited to, indicative of one or more demographic characteristics of an entity (e.g., age, gender, income, etc.), variables indicative of prior actions or transactions involving the entity (e.g., information that can be obtained from credit files or records, financial records, consumer records, or other data about the activities or characteristics of the entity), variables indicative of one or more behavioral traits of an entity, etc.

The predicted risk indicator can be utilized by the service or resource provider to determine the risk associated with the entity accessing a service provided by the service or resource provider, thereby granting or denying access by the entity to an interactive computing environment implementing the service or providing the resource. For example, if the service provider determines that the predicted risk indicator is lower than a threshold risk indicator value, then the client computing system 104 associated with the service provider can generate or otherwise provide access permission to the user computing system 106 that requested the access. The access permission can include, for example, cryptographic keys used to generate valid access credentials or decryption keys used to decrypt access credentials. The client computing system 104 associated with the service provider can also allocate resources to the user and provide a dedicated web address for the allocated resources to the user computing system 106, for example, by adding it in the access permission. With the obtained access credentials and/or the dedicated web address, the user computing system 106 can establish a secure network connection to the computing environment hosted by the client computing system 104 and access the resources via invoking API calls, web service calls, HTTP requests, or other proper mechanisms.

Each communication within the operating environment 100 may occur over one or more data networks, such as a data network 108, a network 116 such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices depicted in FIG. 1 is provided for illustrative purposes. Different numbers of devices may be used. For example, while certain devices or systems are shown as single devices in FIG. 1, multiple devices may instead be used to implement these devices or systems.

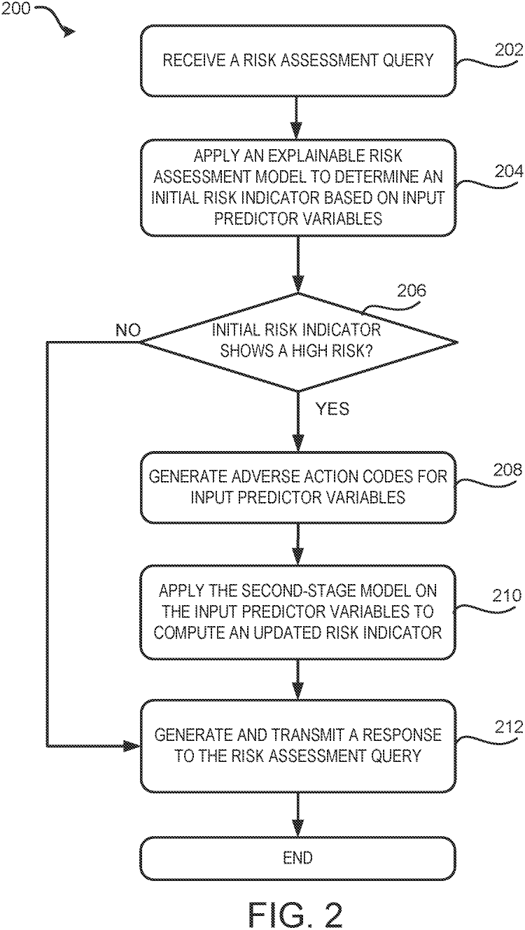

FIG. 2 is a flow chart depicting an example of a process 200 for utilizing an explainable risk assessment model 132 and a second-stage risk assessment model 120 to generate risk indicators for a target entity based on predictor variables associated with the target entity. One or more computing devices implement operations depicted in FIG. 2 by executing suitable program code. For example, the risk assessment server 118 may implement the operations depicted in FIG. 2 by executing the program code for the risk assessment application 114. For illustrative purposes, the process 200 is described with reference to some examples depicted in the figures. Other implementations, however, are possible.

At block 202, the process 200 involves receiving a risk assessment query for a target entity from a remote computing device. The risk assessment server 118 can implement block 202. The risk assessment query can be received from a computing device associated with the target entity requesting the risk assessment, such as a user computing system 106. The risk assessment query can also be received from a remote computing device associated with an entity authorized to request a risk assessment of the target entity, such as a client computing system 104.

At block 204, the process 200 involves applying, to input predictor variables or other data suitable for assessing risks associated with the target entity, an explainable risk assessment model 132 and thereby determining an initial risk indicator for the target entity. The risk assessment server 118 can employ the risk assessment application 114 to implement block 204. Examples of predictor variables can include data associated with an entity that describes prior actions or transactions involving the entity (e.g., information that can be obtained from computing system logs, online activity records, credit files or records, financial records, consumer records, or other data about the activities or characteristics of the entity), behavioral traits of the entity, demographic traits of the entity, or any other traits that may be used to predict risks associated with the entity. The risk indicator can indicate a level of risk associated with the entity, such as a risk score indicating the likelihood of a computer posing a security threat to a computing environment, a credit score of the entity, and so on.

An explainable risk assessment model can be, for example, a model in which the impact of the input predictor variables on the output risk indicator (e.g., the risk score or the credit score) can be determined quantitatively or qualitatively. For instance, a risk assessment model is explainable if, given a change to one or more of the input predictor variables, the change to the output risk indicator can be determined. The determined change to the output risk indicator can be a direction of the change (e.g., an increase or a decrease of the risk indicator value) or the amount of the change in the value of the risk indicator. The explainable risk assessment model 132 can include (or be built based on) models such as linear regression model, logistic regression models, monotonic neural networks, monotonic decision trees, and so on. For example, a monotonic neural network trained with the monotonic constraints that the output of the network changes monotonically as each input predictor variable changes can be used as the explainable risk assessment model 132. As such, the output of the monotonic neural network increases as an input predictor variable increases (or decreases). This monotonic relationship can be utilized to determine impact of a change to an input predictor variable on the change to the output risk indicator.

At block 206, the process 200 involves determining if the initial risk indicator shows a threshold risk associated with the target entity. The risk assessment server 118 can employ the risk assessment application 114 to implement block 206. The risk assessment server 118 can determine that the initial risk indicator shows a high risk for the target entity if the risk indicator has a value higher than a threshold risk value (and thus indicating a higher risk than the threshold risk). In some cases, the high risk can indicate an adverse action with respect to the target entity. If the risk assessment query is for assessing the risk associated with granting access to resources (e.g., by approving the access to online computing resources or by approving an application for credit) by the target entity, the initial risk indicator showing a high risk for the target entity can indicate an adverse action of denying the access or the application.

If a high risk is associated with the target entity, the process 200 involves, at block 208, generating explanatory data (e.g., adverse action codes) for the input predictor variables. The risk assessment server 118 can employ the risk assessment application 114 to implement block 208. As noted above, the impact of the input predictor variables on the initial risk indicators can be determined through the explainable risk assessment model 132. For this reason, the risk assessment server 118 can also utilize the explainable risk assessment model 132 to generate adverse action codes or other explanatory data for at least some of the predictor variables, respectively. An adverse action code can indicate an effect or an amount of impact that a given predictor variable has on the value of the credit score or other risk indicator (e.g., the relative negative impact of the predictor variable on a risk score or other risk indicator). In some aspects, the adverse action codes can be generated in compliance with regulations, business policies, or other criteria used to generate risk evaluations. Examples of regulations to which the risk assessment models conform and other legal requirements include the Equal Credit Opportunity Act (“ECOA”), Regulation B, and reporting requirements associated with ECOA, the Fair Credit Reporting Act (“FCRA”), the Dodd-Frank Act, and the Office of the Comptroller of the Currency (“OCC”).

In some implementations, the explanatory data can be generated for a subset of the predictor variables that have the highest impact on the risk indicator. For example, the risk assessment application 114 can determine a rank of each predictor variable based on an impact of the predictor variable on the risk indicator generated by the explainable risk assessment model 132. A subset of the predictor variables including a certain number of highest-ranked predictor variables can be selected. Explanatory data can be generated for the selected predictor variables. Based on the generated explanatory data, the risk assessment application 114 may provide recommendations to a target entity. The recommendations may indicate one or more actions that the target entity can take to improve the risk indicator (e.g., improve a risk score or a credit score).

At block 210, the process 200 involves applying the second-stage risk assessment model 120 to the input predictor variables or other data suitable for assessing risks associated with the target entity and thereby generating an updated risk indicator for the target entity. The risk assessment server 118 can employ the risk assessment application 114 to implement block 210. The second-stage risk assessment model 120 does not need to be an explainable risk assessment model, and can therefore be generated or configured without an explainability constraint. For instance, the second-stage risk assessment model 120 could be a model that is generated or configured without any requirements for the impact of the input predictor variables on the output risk indicators to be determinable. As such, the second-stage risk assessment model 120 can employ more complicated model structures to provide a more accurate prediction of the risk indicator than the explainable risk assessment model 132. In some examples, the second-stage risk assessment model 120 can be implemented using advanced machine-learning techniques, such as deep learning models. Examples of deep learning models include, but are not limited to, supervised or unsupervised deep neural networks, convolutional neural networks, recurrent neural networks, recursive neural networks, or any combination thereof. Predictor variables associated with the target entity can be used as inputs to the second-stage risk assessment model 120 and the output of the second-stage risk assessment model 120 can include the updated risk indicator for the target entity. In some examples, the second-stage risk assessment model is applied with the consent of the target entity. If the target entity does not consent to using the second-stage risk assessment model, block 210 is skipped.

At block 212, the process 200 involves generating and transmitting a response message to the risk assessment query. The risk assessment server 118 can employ the risk assessment application 114 to implement block 212. The response message can include the initial risk indicator generated using the explainable risk assessment model 132. If the explanatory data and the updated risk indicator generated by the second-stage risk assessment model 120 are available, they can also be included in the response message. The initial risk indicator and the updated risk indicator can be used to determine actions taken with respect to the target entity based on a predicted risk associated with the target entity.

In one example, the risk indicators can be utilized to control access to one or more interactive computing environments by the target entity. As discussed above with regard to FIG. 1, the risk assessment computing system 130 can communicate with client computing systems 104, which may send risk assessment queries to the risk assessment server 118 to request risk assessment. The client computing systems 104 may be associated with technological providers, such as cloud computing providers, online storage providers, or financial institutions such as banks, credit unions, credit-card companies, insurance companies, or other types of organizations. The client computing systems 104 may and be implemented to provide interactive computing environments for users to access various services offered by these service providers. Users can utilize user computing systems 106 to access the interactive computing environments, thereby accessing the services provided by these providers.

For example, a user can submit a request to access the interactive computing environment using a user computing system 106. Based on the request, the client computing system 104 can generate and submit a risk assessment query for the user to the risk assessment server 118. The risk assessment query can include, for example, an identity of the customer and other information associated with the user that can be utilized to generate predictor variables. The risk assessment server 118 can perform risk assessment based on predictor variables generated for the user as described herein and return the predicted risk indicator(s) to the client computing system 104.

Based on the received risk indicator, the client computing system 104 can determine whether to grant the user access to the interactive computing environment. If the client computing system 104 determines that the level of risk associated with the user accessing the interactive computing environment and the associated services (e.g., technical or financial services) is too high, the client computing system 104 can deny access by the customer to the interactive computing environment. Conversely, if the client computing system 104 determines that the level of risk associated with the user is acceptable, the client computing system 104 can grant access to the interactive computing environment by the user and the user would be able to utilize the various services provided by the service providers. For example, with the granted access, the user can utilize the user computing system 106 to access clouding computing resources, online storage resources, web pages or other user interfaces provided by the client computing system 104 to execute applications, store data, query data, submit online digital applications, operate electronic tools, or perform various other operations within the interactive computing environment hosted by the client computing system 104.

### Machine Learning

Both stages involve machine learning algorithms. The first stage of the process can involve the explainable machine learning model such as logistic regression. The second stage can involve a black-box model which may be hard to accomplish a mathematical global explainability of the results. In either stage, generating the risk indicator using a machine learning model can include three components. The first component is a set of features created from a group of entities with the risk information. The set of features for each entity can include the same risk information or transformations thereof. For instance, current salary and the average of the past 12 salaries can be used as features for an individual. The features are approved by FCRA. Finally, the entities can be separated into a training group and a validation and a test group, and these entities are not the same entities for which the risk indicators are to be calculated.

The second component is to define a target variable that discriminates between “good” and “bad” entities and, in some examples, how likely the entities are going to release the resources allocated to it on time (e.g., how likely an individual is going to pay). For example, this definition can be based on the client’s number of days after the due date (days past due, DPD) and the amount past due. For example, a client is marked “good” if he has less than 60 DPD (with a tolerance of $3) in the 6 months from the first due date. Then, the target variable is a vector of 0′s and 1′s where 0 represents a bad user and 1 represents a good user.

The third component is to choose the mathematical model that can be used to relate the features with the target variable. A mathematical model is defined by a mathematical function of the features and a vector of parameters. Denote the mathematical function as M, the features of the customer as x, and the parameters as C. Then, the output of the mathematical model can be a score for each entity:

$$S c o r e \left(x\right) = M \left(x , C\right) \qquad \text{(1)}$$

In some examples, in problems where the target variable is 1 or 0, the M function can be the logistic function:

$$M \left(x , C\right) = \frac{1}{1 + exp \left(- c ⋅ x + {c}_{0}\right)} . \qquad \text{(2)}$$

For example, in this model, the score can represent the probability of a customer to pay a credit card. Then, customers with high probability, for instance above 0.5, are accepted and customers with low probability are rejected.

Note that in order to fully define the mathematical model, values for the parameters C need to be determined through the training process. To calculate these values, the following optimization procedure can be used. Let X be the matrix of features, where each row represents an entity in the training set and assuming there are N entities. Let y be the target variable for those entities. Loss denotes a loss function. The loss function allows the features X and the target variable y to be connected and represents how close the model is to the target variable.

The loss function for problems where the target variable is 0 or 1 can be the binary cross entropy given by the following expression:

$$\begin{matrix}L o s s \left(M \left(X , c\right) , y\right) = {\sum }_{i = 1}^{N} {y}_{i} l o g \left(M \left({X}_{i} , c\right)\right) + \left(1 - {y}_{i}\right) l o g \left(1 -\right) \\ \left(M \left({X}_{i} , c\right)\right)\end{matrix} \qquad \text{(3)}$$

The optimal parameters of the model are defined by

$$C = a r g m i {n}_{c} L o s s \left(M \left(X , c\right) , y\right) . \qquad \text{(4)}$$

The calculation of the argmin is an optimization problem that can be solved using the gradient descent algorithm or variations of it. In another example, the loss function can be defined as

$$\begin{matrix}L o s s \left(M \left(X , c\right) , y\right) \\ = {\sum }_{i = 1}^{N} {y}_{i} log \left(M \left({X}_{i} , c\right)\right) + \left(1 - {y}_{i}\right) log \left(1 - M \left({X}_{i} , c\right)\right) + {λ}_{1} \sum {\left|{c}_{i}\right|}^{2} + \\ {λ}_{2} \sum \left|{c}_{i}\right|\end{matrix} \qquad \text{(5)}$$

where λ₁ and λ₂ are hyperparameters which can be given at the time of the training.

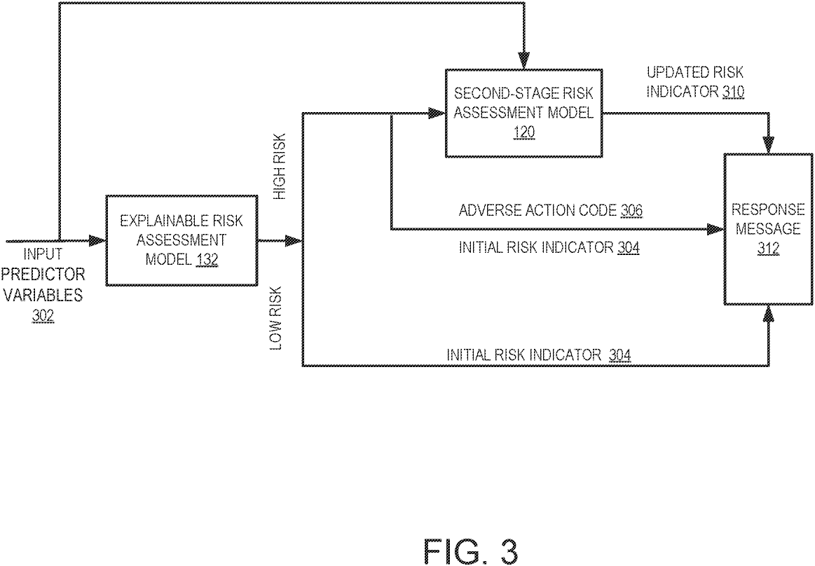

Referring now to FIG. 3, a block diagram illustrating an example of determining the risk indicator(s) based on the explainable risk assessment model 132 and the second-stage risk assessment model 120 is presented. As shown in FIG. 3, the risk assessment computing system 130 can utilize predictor variables 302 associated with a target entity as inputs and generate an initial risk indicator 304 for the target entity using the explainable risk assessment model 132. In some examples, the logistic regression model defined below can be used:

$$M \left(x , C\right) = \frac{1}{1 + exp \left(- c ⋅ x + {c}_{0}\right)} , \qquad \text{(6)}$$

where x are features of a customer and the parameters c are the parameters of the model that are determined using the training procedure described above.

Depending on the value of the initial risk indicator 304, the second-stage risk assessment model 120 may or may not be used for the target entity. If the initial risk indicator 304 generated by the explainable risk assessment model 132 indicates a high risk, such as having a risk indicator value higher than a predetermined threshold risk value, the risk assessment server 118 can further apply the second-stage risk assessment model 120 to the input predictor variables 302 to generate an updated risk indicator 310. In some examples, the second-stage risk assessment model 120 is applied if the target entity consents on using the second-stage risk assessment model 120. If the target entity does not consent, then the second-stage risk assessment model 120 is not used.

In some examples, the family of the techniques being used in the second-stage risk assessment model 120 depends on the consent of the entity. As long as the entity consents to the use of more complex algorithms to explore better opportunities for getting better results compared to stage 1, the more complex algorithms can be used. For example, deep learning algorithms, which are based on the multilayer perceptron, can be used. In some examples, a neural network model can be used. The neural network model can include input layer nodes and hidden layer nodes, and output layer nodes. In each hidden layer node, the following calculation is performed:

$$f \left(b + {\sum }_{i = 1}^{n} {x}_{i} {w}_{i}\right) \qquad \text{(7)}$$

The node receives the values x₁,..., xₙ from previous neurons and multiply each value with weights w₁, ..., wₙ and adds a constant b. Then, it applies a function f to the result. The values w₁, ..., wₙ and b are parameters of the model. In this case, each node adds up to n+1 parameters. The function f is specific to each layer. The values of the first hidden layer are passed to the nodes of the second layer and so on up to the output layer. The calculation of the output layer involves a function that defines the risk indicator. The neural network is able to capture complex relations in the underlying data via the multiple connections between nodes and multiple layers.

For the initial risk indicator 304 indicating a high risk, the risk assessment server 118 can also employ the explainable risk assessment model 132 to generate the adverse action codes 306 such as reason codes for the input predictor variables as discussed above. In examples where the risk indicator indicates a credit score, the model can return up to four reason codes to indicate the key factors that led to a consumer receiving a score that was less than the maximum possible. The model can also be designed to return a required fifth reason code (sometimes referred to as the “FACTA reason code”) when an inquiry on a consumer’s credit file adversely impacts the score calculation but is not included in the top four reason codes. If points assigned are associated with the maximum attribute value, those attributes are blocked from being used in assigning reason codes. In cases where the score cannot be returned, a reject code is delivered.

The reason codes can be generated for the logistic regression model, linear regression, monotonic decision trees, and monotonic neural networks. In some examples, attributes (e.g., predictor variables) are grouped into multiple groups and each group of attributes share the same reason code. This occurs when a large number of related attributes are in the model, or when elevated collinearity is present among the predictor attributes. A grouping of attributes can be judgmental or data driven. After a predictive model has been built and it is determined that shared reason codes are desirable because of a reason above, attributes are grouped into “explanatory concepts”. Explanatory concepts are judgmental or data driven groupings of attributes that allow a model to be explained and used to provide reason codes. Explanatory concepts are computed in one of two ways. If attribute groupings are judgmental based on expert opinion, then a confirmatory factor analysis is completed to ensure that each attribute in a specific grouping is related to a latent common factor. Confirmatory factor analysis provides a hypothesis test of this statement. If attribute groupings are data driven, then an exploratory factor analysis is performed to determine latent common factors in the multiple groups. In either case, after the common factors are determined, the following can be checked: the common factors are interpretable, the factor analysis fit is acceptable according to scientific standards, and collinearity between the common factors, including any trivial factors, is below industry standard thresholds.

In some examples, the risk assessment server 118 can further generate a new set of explanatory data to indicate, in addition to the adverse action codes and the risk indicators, whether a favorable action is recommended for the target entity. The new set of explanatory data can be generated based on the initial indicator, the updated risk indicator or both. In some examples, the new set of explanatory data is generated if the updated risk indicator shows a low risk associated with the target entity. In other words, the new set of explanatory data is generated if both the initial risk indicator shows a high risk associated with the target entity and the updated risk indicator shows a low risk associated with the target entity. This new set of explanatory data can thus be utilized by, for example, the client computing system 104 to determine whether to grant the target entity access to the interactive computing environment.

If the initial risk indicator 304 generated by the explainable risk assessment model 132 indicates a low risk (e.g., the risk indicator value is lower than the predetermined threshold risk value), the second-stage risk assessment model 120 is not used to generate an updated risk indicator. The initial risk indicator 304 and the adverse action codes 306 generated by the explainable risk assessment model 132, the updated risk indicator 310 generated by the second-stage risk assessment model 120, and the set of new explanatory data can be included in a response message 312 for the risk assessment query.

### Example of Computing System

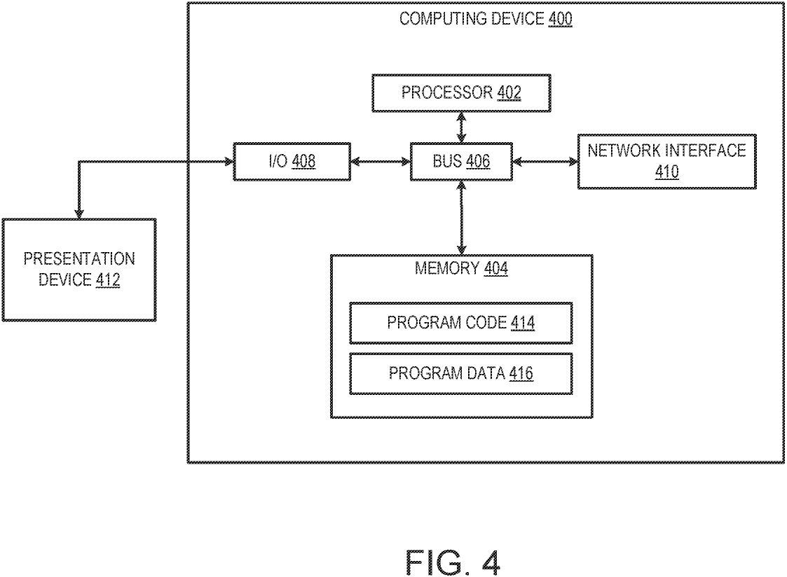

Any suitable computing system or group of computing systems can be used to perform the operations for the machine-learning operations described herein. For example, FIG. 4 is a block diagram depicting an example of a computing device 400, which can be used to implement the risk assessment server 118. The computing device 400 can include various devices for communicating with other devices in the operating environment 100, as described with respect to FIG. 1. The computing device 400 can include various devices for performing one or more transformation operations described above with respect to FIGS. 1-3.

The computing device 400 can include a processor 402 that is communicatively coupled to a memory 404. The processor 402 executes computer-executable program code stored in the memory 404, accesses information stored in the memory 404, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others.

Examples of a processor 402 include a microprocessor, an application-specific integrated circuit, a field-programmable gate array, or any other suitable processing device. The processor 402 can include any number of processing devices, including one. The processor 402 can include or communicate with a memory 404. The memory 404 stores program code that, when executed by the processor 402, causes the processor to perform the operations described in this disclosure.

The memory 404 can include any suitable non-transitory computer-readable medium. The computer-readable medium can include any electronic, optical, magnetic, or other storage device capable of providing a processor with computer-readable program code or other program code. Non-limiting examples of a computer-readable medium include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language include Hadoop, C, C++, C#, Visual Basic, Java, Python, Perl, JavaScript, ActionScript, etc.

The computing device 400 may also include a number of external or internal devices such as input or output devices. For example, the computing device 400 is shown with an input/output interface 408 that can receive input from input devices or provide output to output devices. A bus 406 can also be included in the computing device 400. The bus 406 can communicatively couple one or more components of the computing device 400.

The computing device 400 can execute program code 414 that includes the risk assessment application 114. The program code 414 for the risk assessment application 114 may be resident in any suitable computer-readable medium and may be executed on any suitable processing device. For example, as depicted in FIG. 4, the program code 414 for the risk assessment application 114 can reside in the memory 404 at the computing device 400 along with the program data 416 associated with the program code 414, such as the predictor variables 124. Executing the risk assessment application 114 can configure the processor 402 to perform the operations described herein.

In some aspects, the computing device 400 can include one or more output devices. One example of an output device is the network interface device 410 depicted in FIG. 4. A network interface device 410 can include any device or group of devices suitable for establishing a wired or wireless data connection to one or more data networks described herein. Non-limiting examples of the network interface device 410 include an Ethernet network adapter, a modem, etc.

Another example of an output device is the presentation device 412 depicted in FIG. 4. A presentation device 412 can include any device or group of devices suitable for providing visual, auditory, or other suitable sensory output. Non-limiting examples of the presentation device 412 include a touchscreen, a monitor, a speaker, a separate mobile computing device, etc. In some aspects, the presentation device 412 can include a remote client-computing device that communicates with the computing device 400 using one or more data networks described herein. In other aspects, the presentation device 412 can be omitted.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification that terms such as “processing,” “computing,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computing systems accessing stored software that programs or configures the computing system from a general purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device.

Aspects of the methods disclosed herein may be performed in the operation of such computing devices. The order of the blocks presented in the examples above can be varied-for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific aspects thereof, it will be appreciated that those skilled in the art, upon attaining an understanding of the foregoing, may readily produce alterations to, variations of, and equivalents to such aspects. Any aspects or examples may be combined with any other aspects or examples. Accordingly, it should be understood that the present disclosure has been presented for purposes of example rather than limitation, and does not preclude inclusion of such modifications, variations, or additions to the present subject matter as would be readily apparent to one of ordinary skill in the art.

1. A method that includes one or more processing devices performing operations comprising:
receiving, from a remote computing device, a risk assessment query for a target entity;
determining, responsive to the risk assessment query, a first risk indicator for the target entity by applying a first risk assessment model to predictor variables associated with the target entity;
responsive to determining that the first risk indicator indicates a risk higher than a threshold value,
generating explanatory data for the predictor variables, the explanatory data indicating an effect that a predictor variable has on the first risk indicator; and
determining a second risk indicator for the target entity by applying a second risk assessment model to the predictor variables associated with the target entity; and
transmitting, to the remote computing device, a response message including the first risk indicator, the explanatory data, and the second risk indicator, for use in controlling access to one or more interactive computing environments by the target entity.

2. The method of claim 1, wherein the first risk assessment model comprises an explainable risk assessment model and the second risk assessment model comprises a second-stage risk assessment model that is generated without an explainability constraint.

3. The method of claim 2, wherein the first risk assessment model comprises a logistic regression model, a linear regression model, monotonic decision trees, or a monotonic neural network.

4. The method of claim 2, wherein the second-stage risk assessment model comprises a deep neural network, a convolutional neural network, a recurrent neural network, or a recursive neural network.

5. The method of claim 1, wherein the operations further comprise:
generating a second set of explanatory data based on the second risk indicator, the second set of explanatory data indicating whether a favorable action is recommended for the target entity; and
including the second set of explanatory data in the response message.

6. The method of claim 1, wherein the explanatory data is generated for a subset of the predictor variables that have the highest impact on the first risk indicator.

7. The method of claim 1, wherein the operations further comprise grouping the predictor variables into a plurality of groups, wherein generating the explanatory data for the predictor variables comprises generating a same reason code for each group of the plurality of groups.

8. A system comprising:
a processing device; and
a memory device in which instructions executable by the processing device are stored for causing the processing device to perform operations comprising:
receiving, from a remote computing device, a risk assessment query for a target entity;
determining, responsive to the risk assessment query, a first risk indicator for the target entity by applying a first risk assessment model to predictor variables associated with the target entity;
responsive to determining that the first risk indicator indicates a risk higher than a threshold value,
generating explanatory data for the predictor variables, the explanatory data indicating an effect that a predictor variable has on the first risk indicator; and
determining a second risk indicator for the target entity by applying a second risk assessment model to the predictor variables associated with the target entity; and
transmitting, to the remote computing device, a response message including the first risk indicator, the explanatory data, and the second risk indicator, for use in controlling access to one or more interactive computing environments by the target entity.

9. The system of claim 8, wherein the first risk assessment model comprises an explainable risk assessment model and the second risk assessment model comprises a second-stage risk assessment model that is generated without an explainability constraint.

10. The system of claim 9, wherein the first risk assessment model comprises a logistic regression model, a linear regression model, monotonic decision trees, or a monotonic neural network.

11. The system of claim 9, wherein the second-stage risk assessment model comprises a deep neural network, a convolutional neural network, a recurrent neural network, or a recursive neural network.

12. The system of claim 8, wherein the operations further comprise:
generating a second set of explanatory data based on the second risk indicator, the second set of explanatory data indicating whether a favorable action is recommended for the target entity; and
including the second set of explanatory data in the response message.

13. The system of claim 8, wherein the explanatory data is generated for a subset of the predictor variables that have the highest impact on the first risk indicator.

14. The system of claim 8, wherein the operations further comprise grouping the predictor variables into a plurality of groups, wherein generating the explanatory data for the predictor variables comprises generating a same reason code for each group of the plurality of groups.

15. A non-transitory computer-readable storage medium having program code that is executable by a processor to cause a computing device to perform operations, the operations comprising:
receiving, from a remote computing device, a risk assessment query for a target entity; determining, responsive to the risk assessment query, a first risk indicator for the target entity by applying a first risk assessment model to predictor variables associated with the target entity;
responsive to determining that the first risk indicator indicates a risk higher than a threshold value,
generating explanatory data for the predictor variables, the explanatory data indicating an effect that a predictor variable has on the first risk indicator; and
determining a second risk indicator for the target entity by applying a second risk assessment model to the predictor variables associated with the target entity; and
transmitting, to the remote computing device, a response message including the first risk indicator, the explanatory data, and the second risk indicator, for use in controlling access to one or more interactive computing environments by the target entity.

16. The non-transitory computer-readable storage medium of claim 15, wherein the first risk assessment model comprises an explainable risk assessment model and the second risk assessment model comprises a second-stage risk assessment model that is generated without an explainability constraint.

17. The non-transitory computer-readable storage medium of claim 16, wherein the first risk assessment model comprises a logistic regression model, a linear regression model, monotonic decision trees, or a monotonic neural network, and the second-stage risk assessment model comprises a deep neural network, a convolutional neural network, a recurrent neural network, or a recursive neural network.

18. The non-transitory computer-readable storage medium of claim 15, wherein the operations further comprise:
generating a second set of explanatory data based on the second risk indicator, the second set of explanatory data indicating whether a favorable action is recommended for the target entity; and
including the second set of explanatory data in the response message.

19. The non-transitory computer-readable storage medium of claim 15, wherein the explanatory data is generated for a subset of the predictor variables that have the highest impact on the first risk indicator.

20. The non-transitory computer-readable storage medium of claim 15, wherein the operations further comprise grouping the predictor variables into a plurality of groups, wherein generating the explanatory data for the predictor variables comprises generating a same reason code for each group of the plurality of groups.
